(19) United States
(12) Patent Application Publication
(10) Pub. No.: US 2013/0292317 A1
(43) Pub. Date: Nov. 7, 2013

(54) Stormwater Catch Basin Filter for Capturing Heavy Metal Contaminants

(71) Applicants: Mark D. Shaw, Ponte Vedra Beach, FL (US); Jacque Hahn, St. Johns, FL (US); Matt Clancy, Jacksonville, FL (US)

(72) Inventors: Mark D. Shaw, Ponte Vedra Beach, FL (US); Jacque Hahn, St. Johns, FL (US); Matt Clancy, Jacksonville, FL (US)

(21) Appl. No.: 13/463,099

(22) Filed: May 3, 2012

(51) Int. Cl. C02F 1/62; B01D 24/04; B01D 15/04

(52) U.S. Cl. 210/266; 210/263; 210/283

(57) ABSTRACT

A catch basin filter having a bag member with a plurality of compartments, the compartments containing heavy metal recovery material, whereby heavy metals in liquid passing through the compartments are filtered from the liquid stream or neutralized.

### BACKGROUND OF THE INVENTION

The invention relates to filters for stormwater catch basins, and more particularly relates to permeable filters of fabric, geotextile, woven or non-woven construction that are capable of absorbing, adsorbing or blocking passage of particulate matter, chemicals, hydrocarbons, etc., whereby the filters are disposed across or within the stormwater catch basin, typically begin retained in place by the catch basin grate, such that stormwater must pass through the filter material before entering the stormwater run-off system.

Ground water from heavy rains or melted snow is collected in stormwater catch basins, usually located on roadsides or in paved lots, and delivered into underground pipes which are then usually discharged into nearby rivers, streams, lakes other water bodies. The water flows into the basin through openings in a removable grate that is positioned on the top of the basin or through a curb inlet. Water entering a underground pipes should be free of solids, particulates and other undesirable contaminants. One form of conventional storm sewer filter removes solids from the water before the water flows into the catch basin. These filters are made of a porous material and are located at or above grade level. The filters may be placed horizontally on the top of the grate or vertically across a curb inlet, or may be set up as an upright wall surrounding the grate above grade level. Water flows freely through the filter and into the catch basin, whereas solids, particulates, etc., are captured by the filter.

Another well-known conventional filter includes a bag formed from a porous filter material having inwardly tapered sidewalls or sidewalls with a bottom. The bag may be supported within the catch basin beneath the grate using mechanical fasteners or frames, or the top of the bag may be joined to a sheet member, often referred to as a skirt, with an opening corresponding to the bag opening, or flaps may be joined to the top of the bag. The skirt or flaps may be porous or non-porous. The grate rests on the skirt or flaps to hold the bag in place in the basin. This bag structure is preferable since the entrapped solids and particulates are retained within the bag and below the grade level. This prevents the accumulated solids and particulates from diverting water flow through the grate and hides the accumulated solids and particulates below the surface. When the bag becomes full, it is removed and emptied.

Examples of such bag filters can be found in U.S. Pat. No. 5,575,925 to Logue, Jr., U.S. Pat. No. 6,149,803 to DiLoreto, Jr. et al., U.S. Pat. No. 6,214,216 to Isaacson, U.S. Pat. No. 6,294,095 to Lewis, and U.S. Pat. No. 7,201,843 to Sasaki et al., the disclosures of which are incorporated herein by reference, with particular regard for the various mechanisms and methods for retention of the bag filters within the stormwater catch basin.

Known catch basin filters are effective in capturing solids and particulates, and with proper filtering materials, hazardous and undesirable liquids such as oil and gasoline. It is now known that stormwater run-off also transports and concentrates heavy metal contaminants in the stormwater system. Examples of heavy metal contaminants include rubidium, lithium, potassium, cesium, ammonium, sodium, calcium, silver, cadmium, lead, zinc, barium, strontium, copper, mercury, magnesium, iron, cobalt aluminum and chromium.

It is an object of this invention, among other objects discernable from the disclosure to follow, to provide a catch basin filter capable of capturing heavy metal contaminants. It is a further object to provide such a catch basin filter that is easily placed in and removed from the catch basin. It is a further object to provide such a catch basin filter having a depending bag member and wherein the heavy metal removal material is retained within compartments on the bag portion.

### SUMMARY OF THE INVENTION

The invention, shown in multiple embodiments, is a stormwater catch basin filter, often referred to as an insert, adapted to be positioned within the opening of a stormwater catch basin and below the catch basin grate, the catch basin filter retained therein by the weight of the grate, by frame members or by mechanical attachment members. The catch basin filter comprises a filter bag member having a plurality of compartments or pouch members, the compartments containing heavy metal recovery material, the compartments being formed of a liquid permeable filter material, usually in sheet form. The individual compartments may be formed independently and joined together to form a continuous member, or the pre-formed compartments may be inserted into pockets to create the filter bag member. The compartments may be created by stitching or bonding seams or joints in a permeable sheet filter material with the heavy metal recovery material inserted therein. In the preferred embodiment, the filter bag member is attached to one or more non-permeable sheet members defining a skirt or flaps, the skirt or flaps being wedged between the grate and the catch basin to secure the filter in place.

In alternative embodiments, the compartments may be oriented in horizontal, vertical or other directions, with horizontal divisions being preferable when the heavy metal recovery material is prone to settling. The compartments may be configured in various shapes, such as for example generally rectangular, square, tubular, disk-shaped or polygonal. The filter bag member may comprise multiple layers of compartments, preferably aligned such that the seams of one layer of compartments are abutted by the bodies of the compartments of the adjoining layer. The filter bag member may comprise internal and/or external layers of permeable sheet filter members adjoining or overlaying the compartments, such as for example the positioning of an oil-absorbing material layer interior to the compartments to remove hydrocarbons from the liquid prior to passage through the heavy metal recovery material.

### BRIEF DESCRIPTION OF THE DRAWINGS

FIG. 1 is a side view of an embodiment of the invention, shown in partial cross-section, with the compartments disposed horizontally.

FIG. 2 is a top view of the embodiment of FIG. 1.

FIG. 3 is a partial cross-sectional view of an alternative embodiment, showing a pair of additional sheet filter members disposed on either side of the compartments.

FIG. 4 is a partial cross-sectional view of an alternative embodiment showing offset layers of compartments.

FIG. 5 is a side view of an alternative embodiment showing the compartments disposed vertically.

FIG. 6 is an exploded view illustrating the positioning of the catch basin filter between the grate and within the catch basin when the catch basin filter is in use.

FIG. 7 is a partial view of an alternative embodiment showing compartments having a polygonal shape.

### DETAILED DESCRIPTION OF THE INVENTION

With reference to the drawings, the invention in its various embodiments will now be described in detail. In a broad and general sense, the invention is a stormwater catch basin filter insert for capturing and removing heavy metal contaminants from stormwater run-off. A typical stormwater catch basin 32, as shown in FIG. 6, is a ground-level, concrete, box-like structure having an open top structured to receive and retain a storm grate 31, typically rectangular or round, the catch basin 32 communicating with an underground conduit component of the stormwater removal or sewer system, such that stormwater run-off passes through the grate 31, through the catch basin 32 and then into the sewer system.

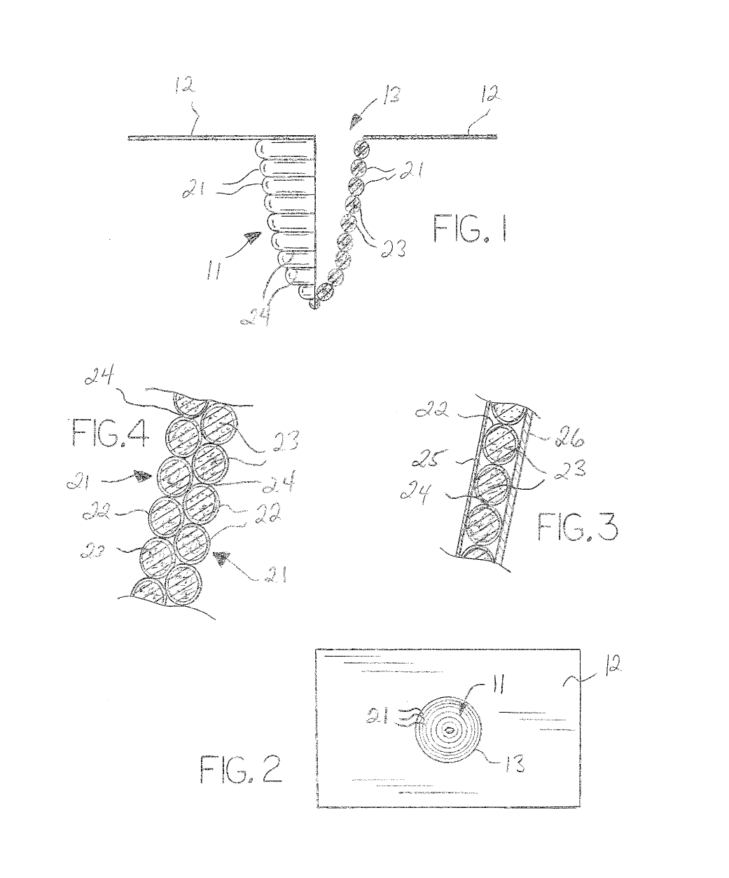

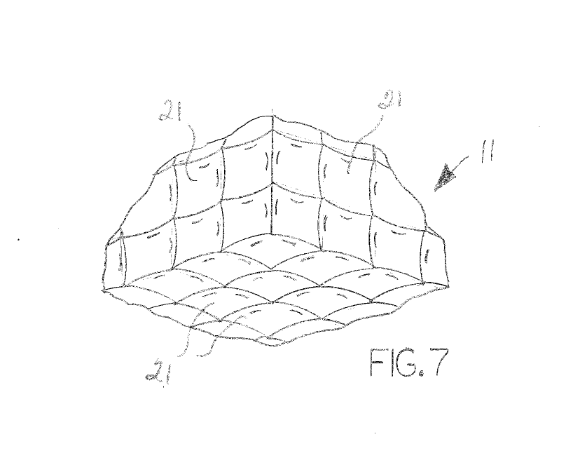

The catch basin filter member comprises a bag member 11 with an upper opening 13 that is adapted to be received within the catch basin 32 beneath the grate 31, such that stormwater flowing through the grate 31 must pass through the catch basin filter member prior to passage into the stormwater system. The opening 13 may be of any size. The bag member 11 provides a receptacle to retain solids and particulate matter that is out of view, and the internal volume of the bag member 11 is one determinant of how frequently the catch basin filter must be removed, cleaned or discarded, then replaced. In many embodiments, the bag member 11 is provided with bypass openings 14 at or a short distance below the opening 13 to allow water to bypass the bag member 11 if the water inflow rate exceeds the water pass-through rate of the porous material comprising the bag member 11 or if the bag member 11 becomes full or clogged. Catch basin filters comprising bag members 11 are well known and are constructed from various fabrics, geotextiles, woven sheet material, non-woven sheet material or the like which provide a porous barrier that retains solids and particulates. It is also known to construct the bag members 11 from porous material that absorbs hydrocarbons. The bag members 11 may comprise various shapes such as for example rounded or tapered, as shown in FIGS. 1, 2 5 and 6, or rectangular, as shown in FIG. 7.

The bag member 11 may be supported in various ways, such as through the use of rigid frame members or mechanical attachment to the catch basin 32, but a preferred mechanism for securing the bag member 11 within the catch basin 32 is to join the bag member 11 to one or more planar sheet members, often referred to as skirt or flap members 12. As shown in FIG. 6, the one or more skirt members 12 extend laterally from the opening 13 and are sized to be of greater dimension than the opening in the catch basin 32 that receives the grate 31, such that with the bag member 11 placed into the opening of the catch basin 32 the one or more skirt members 12 will be wedged between the grate 31 and the catch basin. In this manner, the weight of the grate 31 maintains the catch basin filter in the catch basin 31 even when the catch basin filter becomes loaded with solids and particulates. Since one of the main purposes of the invention is to capture and remove heavy metal contaminants, it is most preferred that the skirt members 12 be composed of a non-porous material impermeable to liquids, thereby insuring that all stormwater run-off will flow into the bag member 11. Straps, loops, anchors, connectors or the like 15 may be attached to the bag member 11 or the sheet members 12 to assist in retention or removal of the catch basin filter.

The removal or neutralization of heavy metal contaminants is accomplished by incorporating heavy metal recovery material 23, usually presented in particulate or granular form, within contiguous compartments 21 that form the bag member 11. The heavy metal recovery material 23 may absorb or adsorb the heavy metal contaminants, or may react with the contaminants to neutralize them prior to passage into the stormwater sewer system. Examples of heavy metal recovery material 23 include activated carbon, charcoal, zeolite and perlite. Various heavy metal recovery materials 23 are capable of removing various heavy metals from a liquid, such as rubidium, lithium, potassium, cesium, ammonium, sodium, calcium, silver, cadmium, lead, zinc, barium, strontium, copper, mercury, magnesium, iron, cobalt, aluminum and chromium. The heavy metal recovery material 23 is preferably retained in segmented or compartmented manner, the compartments 21 being touching or contiguous, since the heavy metal recovery material 23 is to be disposed throughout the bag member 11 to insure that all or the majority of water passing through the bag member 11 must contact or pass through the heavy metal recovery material 23. The compartments 21 may have various shapes, such as for example tubular or elongated, as shown in FIGS. 1 and 5, or polygonal or disk-like, as shown in FIG. 7.

The walls of the compartments 21 are composed of porous sheet filter members 22, the material of composition being suitable to retain the heavy metal recovery material 23 therein while liquid passes through. The compartments 21 may be formed separately and then connected together to form bag member 11 by stitching, bonding or the like. Alternatively, the compartments 21 may be formed by intermittently stitching or bonding two porous sheet filter members 22 to create joints or seams 24, the heavy metal recovery material 23 having been disposed between the two sheet filter members 22 prior to creating the seams 24 or loaded into the pockets formed in the two sheet filter members 22 after stitching. The compartments 21 may be arranged in various orientations, and may for example extend generally horizontally to define annular rings, as shown in FIGS. 1-4, vertically, as shown in FIG. 5, or in a tile-like or quilt-like orientation, as shown if FIG. 7.

In alternative embodiments, the bag member 11 may comprise additional filtering layers or members, such as an internally disposed filter layer 25 or an externally disposed filter layer 26, as shown in FIG. 3. The internal/external filter layers 25/26 may be composed of the same or different materials of composition as the sheet filter members 22 encompassing the heavy metal recovery material 23, and may have differing thicknesses, densities or other structural variations to control or account for flow rates and desired residence time for the liquid to be in contact with the heavy metal recovery material 23 Likewise, the thickness of the compartments 21 can be varied to control flow rate and residence time. In a preferred embodiment, the internal filter layer 25 is composed of a material that absorbs hydrocarbons, thereby removing the hydrocarbons from the permeating liquid prior to contact with the heavy metal recovery material 23 to prevent clogging. As another example, anti-microbial material may be placed into the compartments 21 or incorporated in the sheet filter members 22 or the internal/external filter layers 25/26. Sampling ports or apertures 16 may be provided in the skirt member 12 or bag member 11.

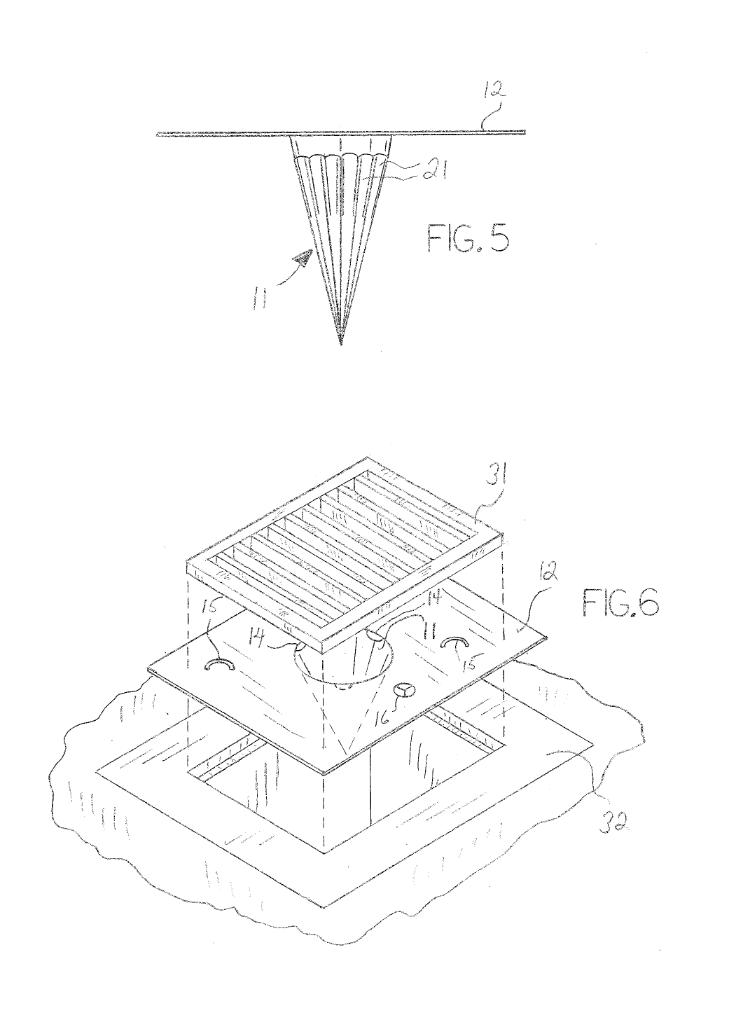

The bag member 11 may also comprise multiple layers of compartments 21, as shown in FIG. 4, wherein the layers are preferably offset such that the midline portion of a compartment 21 in a first layer abuts the seam 24 of the adjoining second layer. The compartments 21 may cover the entire surface of bag member 11 up to the opening 13, or the lower portion of the bag member 21 may be composed of compartments 21 while the upper portion of bag member 11 is composed only of sheet filter member 22 and remains free of compartments 21, such that in the event the flow rate of the water flowing into the catch basin filter exceeds the water flow rate through the compartments 21, the water will then flow through the sheet filter member 22 in the upper portion of the bag member 11, thereby preventing water from backing up to ground level.

It is contemplated that equivalents and substitutions for elements and structures described above may be obvious to those of ordinary skill in the art, and therefore the true scope and definition of the invention is to be as set forth in the following claims.

We claim:

1. A catch basin filter comprising:
a liquid permeable bag member comprising a top opening and compartments containing heavy metal recovery material.

2. The catch basin filter of claim 1, further comprising a skirt member attached to said bag member.

3. The catch basin filter of claim 1, wherein said compartments extend horizontally.

4. The catch basin filter of claim 1, wherein said compartments extend vertically.

5. The catch basin filter of claim 1, wherein said compartments are tubular.

6. The catch basin filter of claim 1, wherein said compartments are polygonal.

7. The catch basin filter of claim 1, wherein said compartments are oriented in tile-like manner.

8. The catch basin filter of claim 1, wherein said compartments comprise two layers of filter sheet material intermittently joined together.

9. The catch basin filter of claim 1, wherein said bag member further comprises an interior filter member.

10. The catch basin filter of claim 1, wherein said bag member further comprises an exterior filter member.

11. The catch basin filter of claim 1, wherein said compartments are disposed in offset layers.

12. The catch basin filter of claim 1, wherein said heavy metal recovery material is chosen from the group of heavy metal recovery materials consisting of activated carbon, charcoal, zeolite and perlite.

13. The catch basin filter of claim 1, wherein said heavy metal recovery material removes from liquid passing through said compartments at least one heavy metal from the group of heavy metals consisting of rubidium, lithium, potassium, cesium, ammonium, sodium, calcium, silver, cadmium, lead, zinc, barium, strontium, copper, mercury, magnesium, iron, cobalt, aluminum and chromium.

14. The catch basin filter of claim 2, wherein said skirt member is liquid impermeable.

15. The catch basin filter of claim 9, wherein said interior filter layer captures hydrocarbons.

16. A catch basin filter comprising:
a liquid permeable bag member comprising a top opening and compartments containing heavy metal recovery material; and
a liquid impermeable skirt member extending laterally from said top opening.

17. The catch basin filter of claim 16, wherein said compartments are formed by joining two liquid permeable filter sheet members in a manner creating a plurality of seams.

18. The catch basin filter of claim 17, wherein said compartments extend horizontally to create annular rings.

19. The catch basin filter of claim 17, wherein said bag member further comprises an interior filter layer composed of a material that captures hydrocarbons.

20. The catch basin filter of claim 17, wherein said compartments are disposed in offset layers.
